(19) United States
(12) Patent Application Publication
(10) Pub. No.: US 2013/0228509 A1
(43) Pub. Date: Sep. 5, 2013

(54) FILTRATION SYSTEM

(71) Applicant: Gokhan Kuruc, Meriden, CT (US)

(72) Inventor: Gokhan Kuruc, Meriden, CT (US)

(21) Appl. No.: 13/881,193

(22) PCT Filed: Feb. 28, 2011
(86) PCT No.: PCT/US2011/026440

§ 371 Date: Apr. 24, 2013

Related U.S. Application Data
(60) Provisional application No. 61/415,616, filed on Nov. 19, 2010.

(51) Int. Cl. B01D 29/88

(52) U.S. Cl. CPC B01D 29/88
USPC 210/435; 29/428

(57) ABSTRACT

A filtration system (20) is disclosed comprising a filter manifold (100) and a filter cartridge (200). The filter cartridge (200) comprises a cartridge body (202) comprising a flow axis (201) and an installation direction orthogonal to the flow axis, a first cartridge port (210) oriented parallel to the flow axis (201) at a first cartridge end (211), the first cartridge port (210) comprising a first extending portion (230) moveable with respect to the cartridge body (202) along the flow axis (201) to a cartridge loading position (234) and a cartridge service position (236), and a second cartridge port (220) oriented parallel to the flow axis (201) at a second cartridge end (221). The filter manifold (100) comprises a first manifold port (110) to fluidly connect to the first cartridge port (210) along the flow axis (201) when the first extending portion (230) is in the cartridge service position (236), and a second manifold port (120) to fluidly connect to the second cartridge port (220).

### BACKGROUND

Fluid filtration systems are common in both residential and industrial settings. Often, such systems include a disposable filter cartridge that removably mounts to a fixed base including fluid connections. When the disposable cartridge is spent, it can be removed from the base, discarded, and replaced with a fresh cartridge. There is an ongoing need to provide fluid filtration systems that offer enhanced performance and ease of mounting and removal.

### SUMMARY OF THE INVENTION

Although filtration systems according to the present disclosure may be useful in any fluid filtration application, they may be particularly useful in the processing of chemical mechanical polishing/planarization (“CMP”) slurries for semiconductor manufacturing. In a typical CMP process, small particles suspended in the slurry are used to polish and/or planarize semiconductor wafers during their manufacture. The slurry is dispensed at a point of use (“POU”) for application to the wafer.

In order to attain consistent and even polishing, it can be important to strictly regulate the size of the particle in the slurry. A typical role of a filter in a CMP process is to allow passage of desirable particles while capturing larger agglomerated particles that can scratch the wafer or cause other defects. In order to achieve this function, a CMP filter must of course be plumbed into the CMP slurry fluid path at some point ahead of the POU. Typically, some amount of plumbing is present between the downstream side of the CMP filter and the POU.

To assist in regulating particle size, it can be desirable to reduce or eliminate areas of dead volume in the fluid paths upstream and/or downstream of the filter cartridge before the slurry reaches the POU. This is because dead volume can result in turbulence or eddies that can cause fluid to stagnate. Stagnating CMP fluid may cause particles to settle out of suspension. When such particles settle out of suspension, they can agglomerate, thus potentially creating large unwanted particulate masses in the fluid stream that can damage the wafer if allowed to reach the POU. Because a CMP filter is intended as a defense against such agglomerates reaching the POU, it can be especially important to reduce or eliminate slurry stagnation in the plumbing between the filter and the POU. Thus, the nature of the fluid connection between the CMP filter and the associated fluid paths can be important.

Filtration systems according to the present disclosure can reduce or eliminate stagnation of CMP slurries upstream and/or downstream of the filter cartridge by providing straight fluid paths into an/or out of the filter cartridge such that the CMP slurry need not follow a tortuous (i.e., stagnation prone) path upon entering and/or leaving the filter cartridge. One way some embodiments of the present disclosure accomplish this is to provide a filter cartridge comprising opposed first and second cartridge ends respectively comprising first and second cartridge ports aligned along—or at least oriented parallel to—a flow axis. In such embodiments, a fluid may flow into the filter cartridge and then and out of the filter cartridge along substantially linear flow paths. In order to accommodate such a filter cartridge, a filter manifold must comprise corresponding opposed first and second manifold ports to engage the opposed first and second cartridge ports.

In such embodiments, because the first and second cartridge ports must seal against or into the first and second manifold ports, the physical end-to-end length of the filter cartridge must be at least as large as the corresponding reception area in the filter manifold. This requirement may cause difficulties because a filter cartridge that is too short may not seal, while a filter cartridge that is too long may not fit within the space provided. Moreover, a filter cartridge that is precisely the correct length to both fit and seal may not be feasible since inevitable manufacturing tolerances in both the filter manifolds and filter cartridges can be difficult to control precisely enough to ensure a consistent fit.

In some embodiments, filtration systems according to the present disclosure can address the above problems by providing a filter cartridge wherein at least one of the first or second cartridge port comprises an extending portion moveable with respect to the cartridge body along the flow axis to a cartridge loading position and a cartridge service position. When in the cartridge loading position, the overall length of the filter cartridge is reduced such that the filter cartridge may be easily loaded into the filter manifold in the installation direction. Then, after loading, the extending portion(s) may be moved to the cartridge service position to fluidly connect the cartridge port(s) to the corresponding manifold port(s). These configurations can provide filtration systems and filter cartridges that can reduce or eliminate upstream and downstream fluid stagnation, do not require extremely precise manufacturing to control tight tolerances, can be easily fit and installed into a filter manifold, and can be reliably sealed into or against the filter manifold.

The present disclosure relates to a filtration system comprising a filter manifold and a filter cartridge. In one embodiment, the filter cartridge comprises a cartridge body comprising a flow axis and an installation direction orthogonal to the flow axis; a first cartridge port oriented parallel to the flow axis at a first cartridge end, the first cartridge port comprising a first extending portion moveable with respect to the cartridge body along the flow axis to a cartridge loading position and a cartridge service position; and a second cartridge port oriented parallel to the flow axis at a second cartridge end. In one embodiment, the filter manifold comprises a first manifold port to fluidly connect to the first cartridge port along the flow axis when the first extending portion is in the cartridge service position; and a second manifold port to fluidly connect to the second cartridge port.

In the above embodiments, the fluid connection between the first manifold port and the first cartridge port may comprise a piston seal.

In the above embodiments, the first manifold port may operate at an elevated pressure while the second manifold port operates near atmospheric pressure.

In the above embodiments, the filter manifold may comprise a first carriage moveable to a manifold loading position and a manifold service position, the first carriage to receive and carry the first extending portion in the installation direction when in the first carriage is in the manifold loading position and the first extending portion is in the cartridge loading position; wherein the first manifold port fluidly connects to the first cartridge port along the flow axis when the first carriage moves to the manifold service position to carry the first extending portion into the cartridge service position.

In the above embodiment, the first carriage may rotate to move to the manifold loading position and the manifold service position.

In the above embodiments, the second manifold port may fluidly connect to the second cartridge port in the installation direction.

In the above embodiments, the second cartridge port may comprise a second extending portion moveable with respect to the cartridge body along the flow axis to a cartridge loading position and a cartridge service position; wherein the second manifold port fluidly connects to the second cartridge port along the flow axis when the second extending portion is in the cartridge service position.

In the above embodiment, the fluid connection between the second manifold port and the second cartridge port may comprise a piston seal.

In the above embodiments, the filter manifold may comprise a second carriage moveable to a manifold loading position and a manifold service position, the second carriage to receive and carry the second extending portion in the installation direction when in the second carriage is in the manifold loading position and the second extending portion is in the cartridge loading position; wherein the second manifold port fluidly connects to the second cartridge port along the flow axis when the second carriage moves to the manifold service position to carry the second extending portion into the cartridge service position.

In the above embodiment, the second carriage may rotate to move to the manifold loading position and the manifold service position.

In the above embodiments, the first carriage and the second carriage may be movable in unison to the manifold loading position and the manifold service position.

In the above embodiments, the cartridge body may be rotatable with respect to the first extending portion, wherein rotation of the cartridge body with respect to the first extending portion about the flow axis urges the first extending portion into the cartridge service position.

In the above embodiments, the first extending portion and the filter manifold may each comprise a retention member, the retention members cooperating to prevent rotation of the first extending portion with respect to the filter manifold when the cartridge body is rotated about the flow axis.

In the above embodiments, the cartridge body may be rotatable with respect to the second extending portion, wherein rotation of the cartridge body with respect to the second extending portion about the flow axis urges the second extending portion into the cartridge service position.

In the above embodiment, the second extending portion and the filter manifold may each comprise a retention member, the retention members cooperating to prevent rotation of the second extending portion with respect to the filter manifold when the cartridge body is rotated about the flow axis.

In the above embodiments, the filter manifold may hold the cartridge body to allow the cartridge body to rotate about the flow axis but not allow the cartridge body to move along the flow axis.

The present disclosure further relates to a filter cartridge comprising a cartridge body comprising a flow axis and an installation direction orthogonal to the flow axis; a first cartridge port oriented parallel to the flow axis at a first cartridge end, the first cartridge port comprising a first extending portion moveable with respect to the cartridge body along the flow axis to a cartridge loading position and a cartridge service position; and a second cartridge port oriented parallel to the flow axis at a second cartridge end.

In the above embodiment, the first cartridge port may comprise one of a piston sealing member or a piston sealing surface.

In the above embodiments, the second cartridge port may comprise a second extending portion moveable with respect to the cartridge body along the flow axis to a cartridge loading position and a cartridge service position.

In the above embodiment, the second cartridge port may comprise one of a piston sealing member or a piston sealing surface.

In the above embodiments, the cartridge body may be rotatable with respect to the first extending portion, wherein rotation of the cartridge body with respect to the first extending portion about the flow axis urges the first extending portion into the cartridge service position.

In the above embodiment, the first extending portion may comprise a retention member, the retention member cooperating with a retention member on a compatible filter manifold to prevent rotation of the first extending portion with respect to the filter manifold when the cartridge body is rotated about the flow axis.

In the above embodiments, the cartridge body may be rotatable with respect to the second extending portion, wherein rotation of the cartridge body with respect to the second extending portion about the flow axis urges the second extending portion into the cartridge service position.

In the above embodiment, the second extending portion may comprise a retention member, the retention member cooperating with a retention member on a compatible filter manifold to prevent rotation of the second extending portion with respect to the filter manifold when the cartridge body is rotated about the flow axis.

In the above embodiments, the filter manifold may hold the cartridge body to allow the cartridge body to rotate about the flow axis but not allow the cartridge body to move along the flow axis.

The present disclosure further relates to a method of assembling a filtration system comprising a filter manifold and a filter cartridge. The filter cartridge comprises a cartridge body comprising a flow axis and an installation direction orthogonal to the flow axis; a first cartridge port oriented parallel to the flow axis at a first cartridge end, the first cartridge port comprising a first extending portion moveable with respect to the cartridge body along the flow axis to a cartridge loading position and a cartridge service position; and a second cartridge port oriented parallel to the flow axis at a second cartridge end. The filter manifold comprises a first manifold port to fluidly connect to the first cartridge port along the flow axis when the first extending portion is in the cartridge service position; and a second manifold port to fluidly connect to the second cartridge port. The method comprises loading the filter cartridge into the filter manifold in the installation direction while the first extending portion is in the cartridge loading position; and moving the first extending portion into the cartridge service position to fluidly connect the first cartridge port to the first manifold port.

In the above embodiment, fluidly connecting the first cartridge port to the first manifold may comprise engaging a piston seal.

In the above embodiments, the method may comprise operating the operating the first manifold port at an elevated pressure and the second manifold port at near atmospheric pressure.

In the above embodiments, the filter manifold may comprise a first carriage moveable to a manifold loading position and a manifold service position, the first carriage to receive and carry the first extending portion in the installation direction when in the first carriage is in the manifold loading position and the first extending portion is in the cartridge loading position. The method may comprise moving the first carriage from the manifold loading position to the manifold service position to carry the first extending portion into the cartridge service position.

In the above embodiment, moving the first carriage from the manifold loading position to the manifold service position may comprise rotating the first carriage.

In the above embodiments, the method may comprise fluidly connecting the second manifold port to the second cartridge port in the installation direction.

In the above embodiments, the second cartridge port may comprise a second extending portion moveable with respect to the cartridge body along the flow axis to a cartridge loading position and a cartridge service position. The method may comprise moving the second extending portion into the cartridge service position to fluidly connect the second cartridge port to the second manifold port.

In the above embodiments, fluidly connecting the second cartridge port to the second manifold may comprise engaging a piston seal.

In the above embodiments, the manifold may comprise a second carriage moveable to a manifold loading position and a manifold service position, the second carriage to receive and carry the second extending portion in the installation direction when in the second carriage is in the manifold loading position and the second extending portion is in the cartridge loading position. The method may comprise moving the second carriage from the manifold loading position to the manifold service position to carry the second extending portion into the cartridge service position.

In the above embodiment, moving the second carriage from the manifold loading position to the manifold service position may comprise rotating the second carriage.

In the above embodiments, the method may comprise moving the first carriage and the second carriage in unison to the manifold loading position and the manifold service position.

In the above embodiments, the cartridge body may be rotatable with respect to the first extending portion. The method may comprise rotating the cartridge body with respect to the first extending portion about the flow axis to urge the first extending portion into the cartridge service position.

In the above embodiment, the first extending portion and the filter manifold may each comprise a retention member. The method may comprise the retention members on the first extending portion and the filter manifold cooperating to prevent rotation of the first extending portion with respect to the filter manifold when the cartridge body is rotated about the flow axis.

In the above embodiments, the cartridge body may be rotatable with respect to the second extending portion. The method may comprise rotating the cartridge body with respect to the second extending portion about the flow axis to urge the second extending portion into the cartridge service position.

In the above embodiment, the second extending portion and the filter manifold may each comprise a retention member. The method may comprise the retention members on the second extending portion and the filter manifold cooperating to prevent rotation of the second extending portion with respect to the filter manifold when the cartridge body is rotated about the flow axis.

In the above embodiments, the filter manifold may hold the cartridge body to allow the cartridge body to rotate about the flow axis but not allow the cartridge body to move along the flow axis.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a perspective view of an exemplary filtration system according to the present disclosure;

FIG. 2A is a cross sectional view taken at 2-2 of FIG. 1 of an exemplary filter manifold according to the present disclosure;

FIGS. 2B-2C are cross sectional views taken at 2-2 of FIG. 1 of an exemplary filtration system according to the present disclosure;

FIG. 2D is a detailed cross sectional view taken at 2-2 of FIG. 1 of an exemplary filter manifold according to the present disclosure;

FIGS. 2E-2F are detailed cross sectional views taken at 2-2 of FIG. 1 of an exemplary filtration system according to the present disclosure;

FIG. 3 is a perspective view of an exemplary filtration system according to the present disclosure;

FIG. 4A is a cross sectional view taken at 4-4 of FIG. 3 of an exemplary filter manifold according to the present disclosure;

FIGS. 4B-4C are cross sectional views taken at 4-4 of FIG. 3 of an exemplary filtration system according to the present disclosure;

FIG. 4D is a detailed cross sectional view taken at 4-4 of FIG. 3 of an exemplary filter manifold according to the present disclosure;

FIGS. 4E-4F are detailed cross sectional views taken at 4-4 of FIG. 3 of an exemplary filtration system according to the present disclosure;

FIG. 5 is a perspective view of an exemplary filtration system according to the present disclosure;

FIG. 6A is a cross sectional view taken at 6-6 of FIG. 5 of an exemplary filter manifold according to the present disclosure;

FIG. 6B is a cross sectional view taken at 6-6 of FIG. 5 of an exemplary filtration system according to the present disclosure;

FIGS. 6C-6D are detailed cross sectional views taken at 6-6 of FIG. 5 of an exemplary filtration system according to the present disclosure;

FIGS. 7-8 are perspective views of an exemplary filtration system according to the present disclosure;

FIG. 9 is a perspective view of an exemplary filtration system according to the present disclosure;

FIG. 10A is a cross sectional view taken at 10-10 of FIG. 9 of an exemplary filter manifold according to the present disclosure;

FIGS. 10B-10C are cross sectional views taken at 10-10 of FIG. 9 of an exemplary filtration system according to the present disclosure;

FIG. 10D is a detailed cross sectional view taken at 10-10 of FIG. 9 of an exemplary filtration system according to the present disclosure; and

FIGS. 11A-11B are schematic views of an exemplary filtration system according to the present disclosure.

### DETAILED DESCRIPTION OF THE DRAWINGS

As shown in the appended Figures, the filtration system 10 may comprise a filter manifold 100 and a filter cartridge 200. In one embodiment, the filter cartridge 200 comprises a cartridge body 202 comprising a flow axis 201 and an installation direction 203 orthogonal to the flow axis 201. The filter cartridge 200 may comprise a filtration media 260 disposed inside the cartridge body 202. Typically, the filtration media 260 surrounds a central core 262. In use, a fluid to be filtered flows into the first cartridge port 210, through the outer surface of the filtration media 260, into the central core 262, and out of the second cartridge port 220. The fluid is supplied to the filter cartridge 200 from the fluid source 116 and is carried away from the filter cartridge 200 through the fluid exit 126, both of which are disposed in the filter manifold 100.

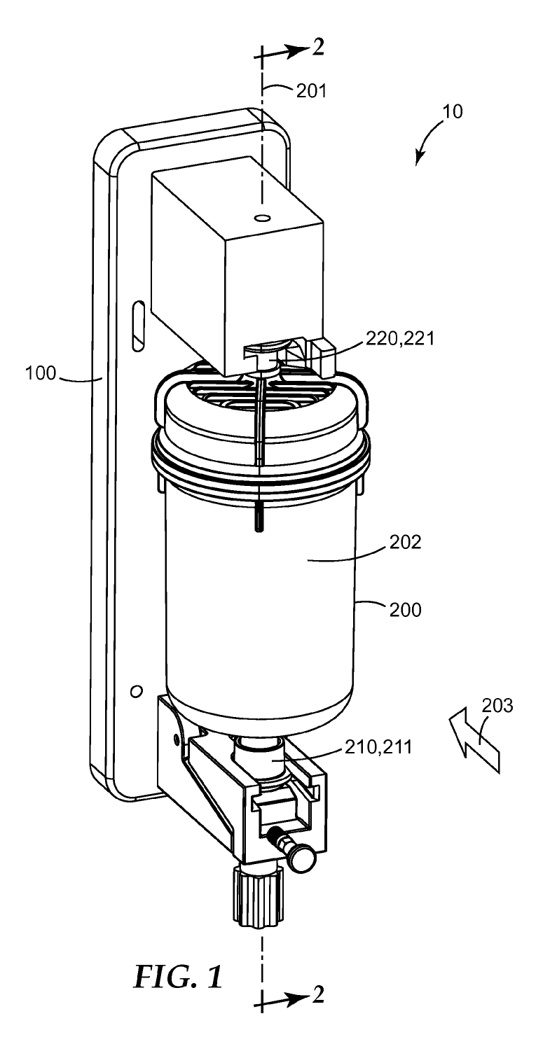

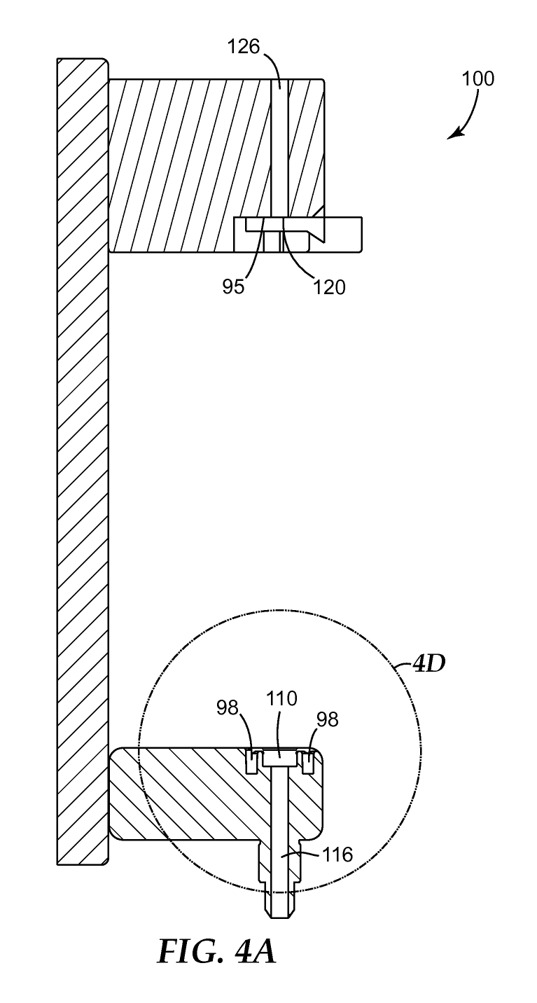

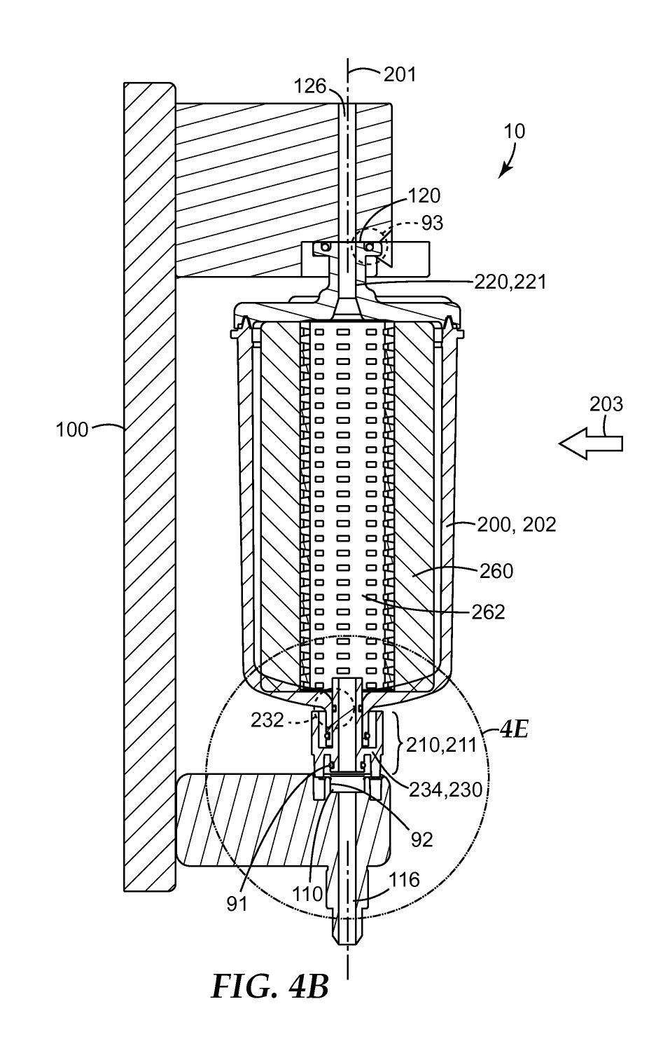

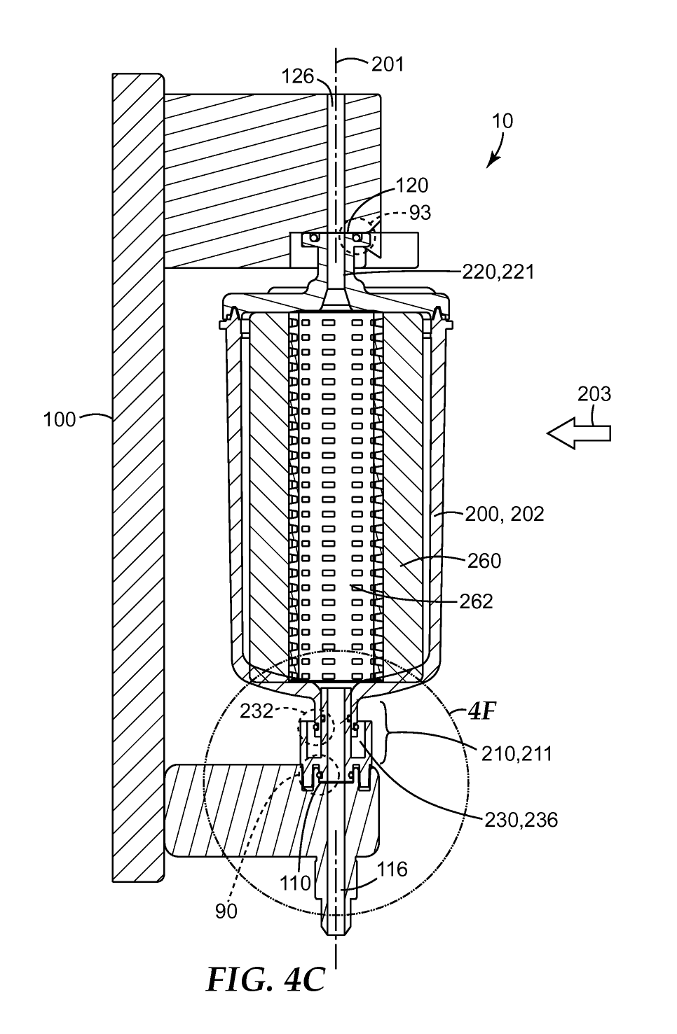

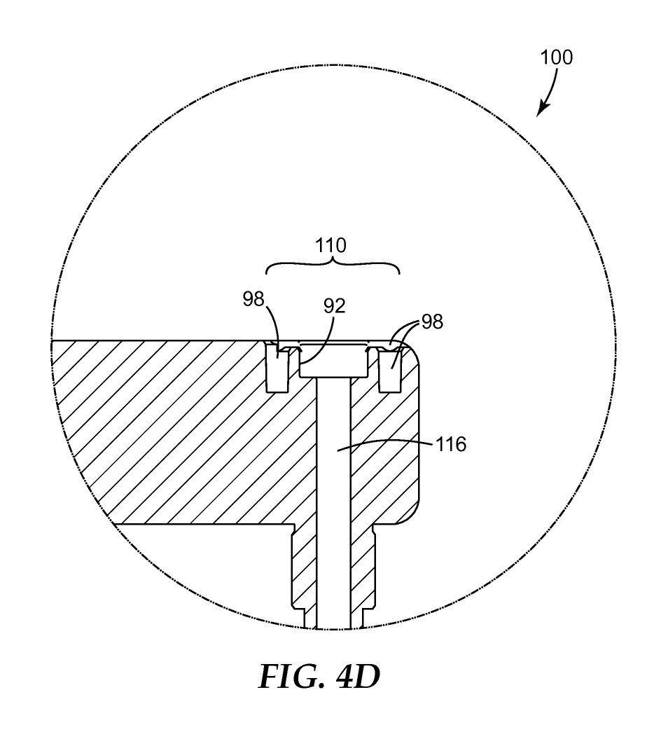

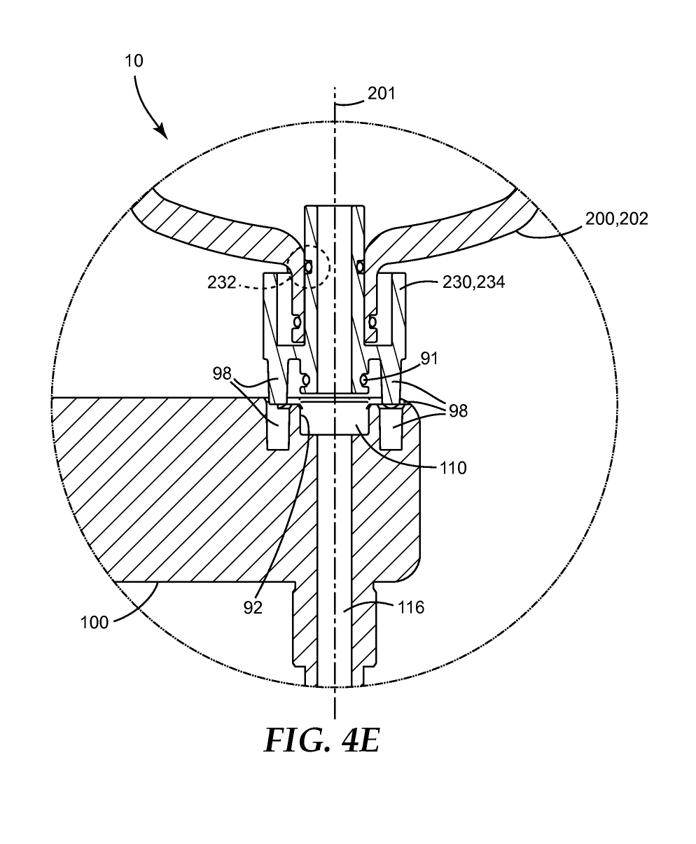

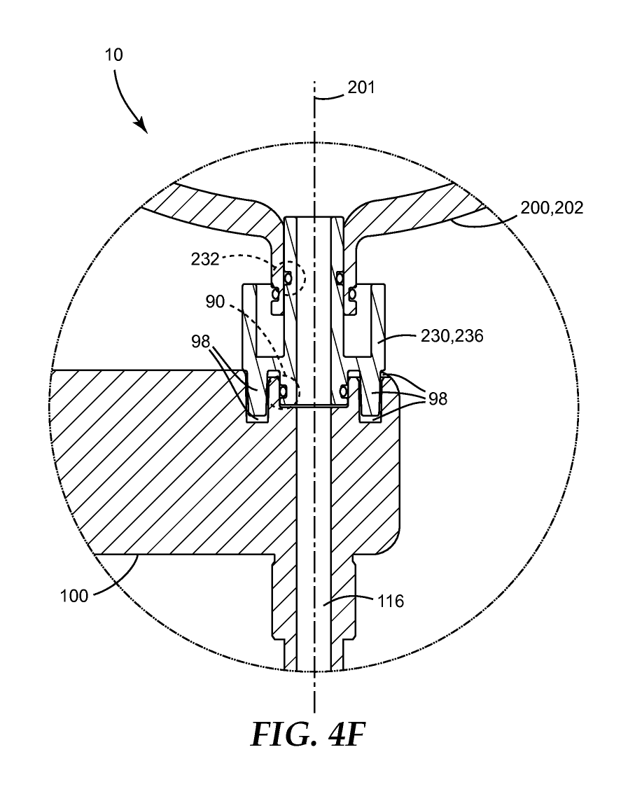

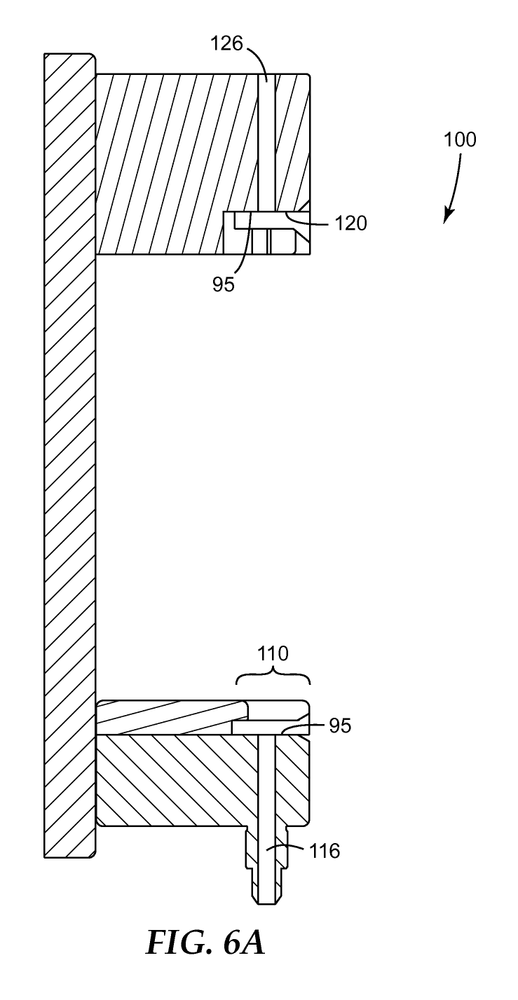

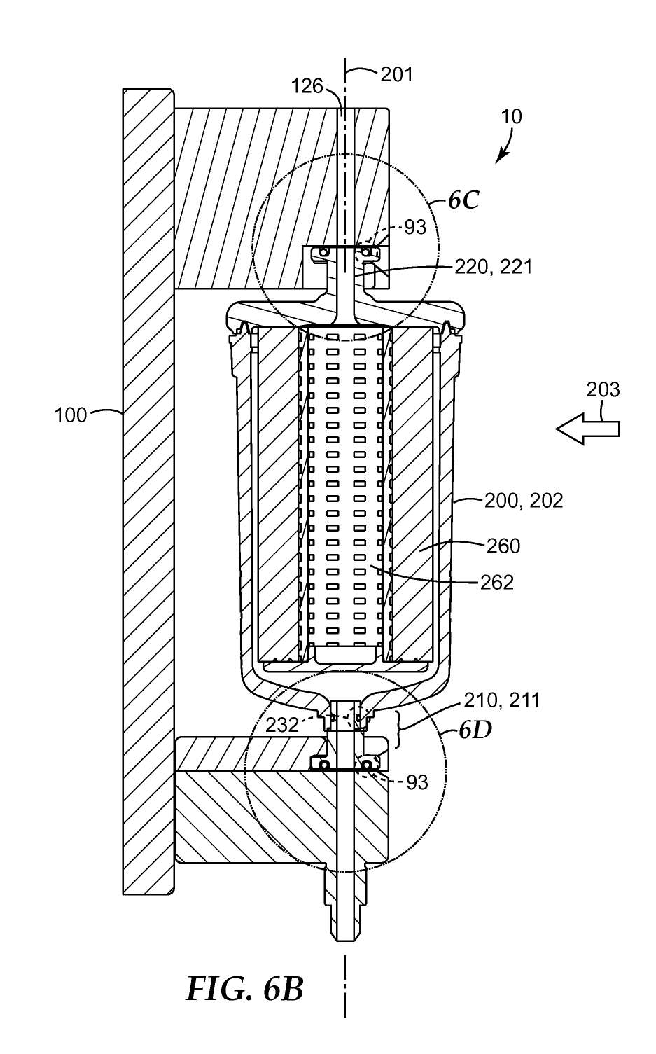

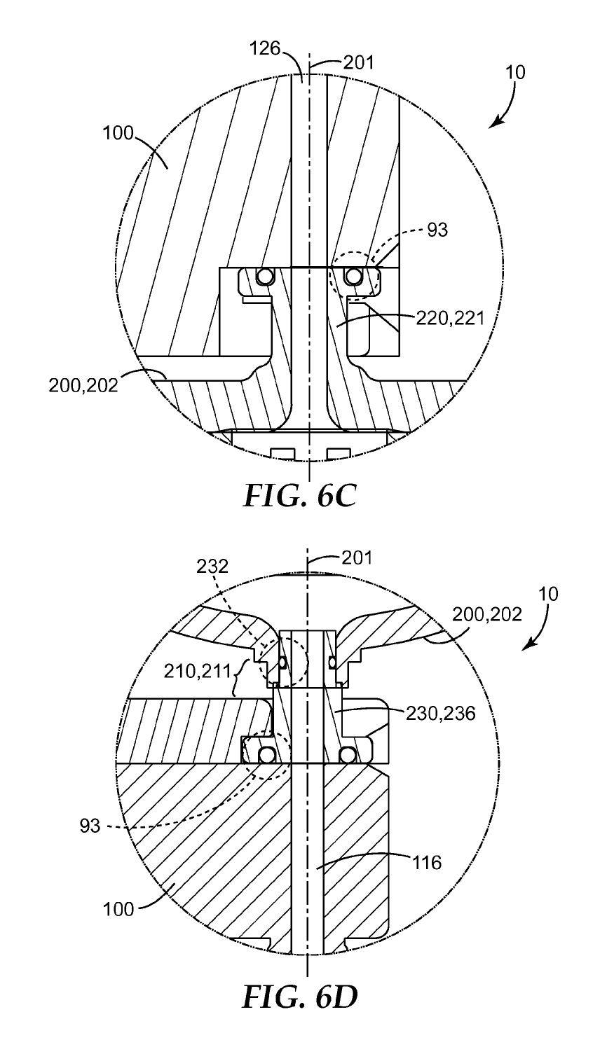

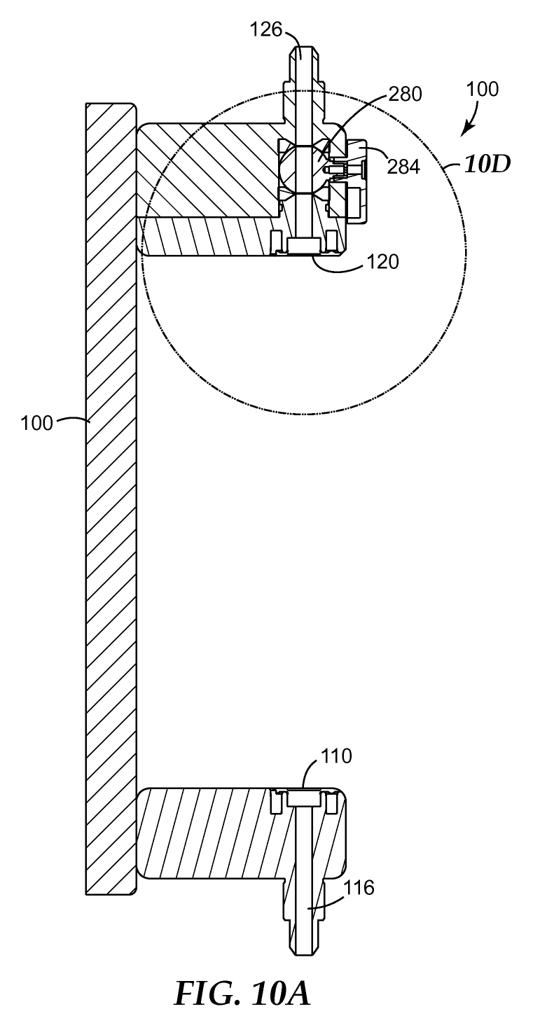

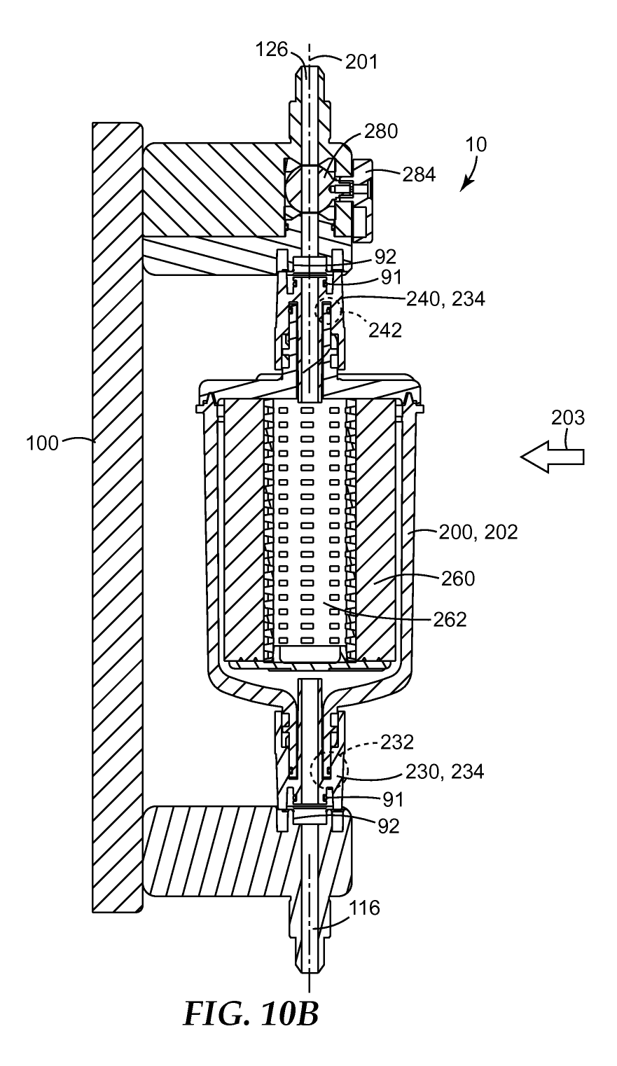

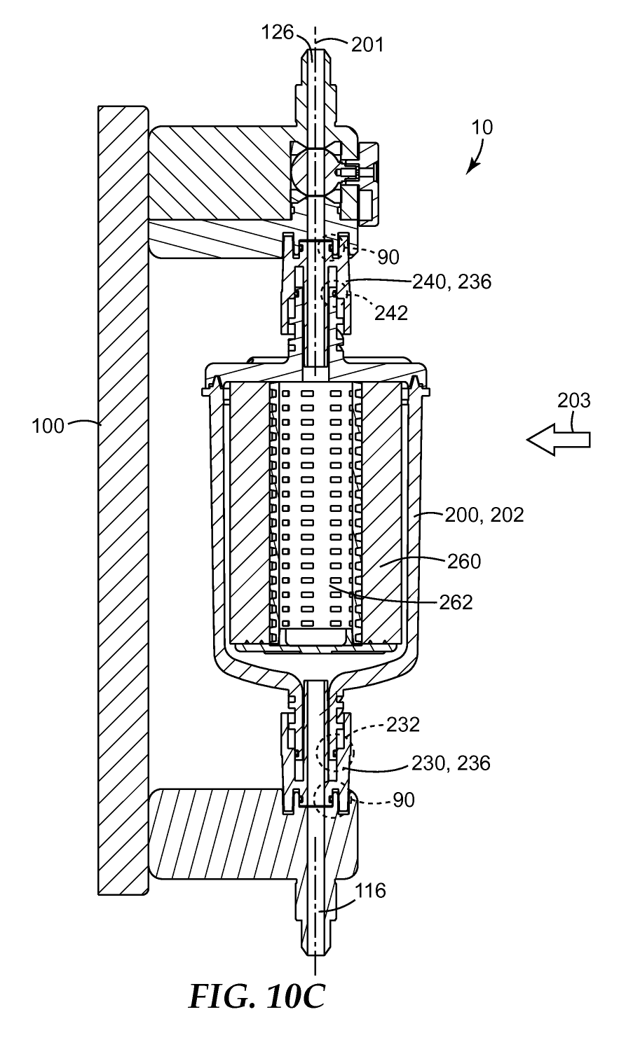

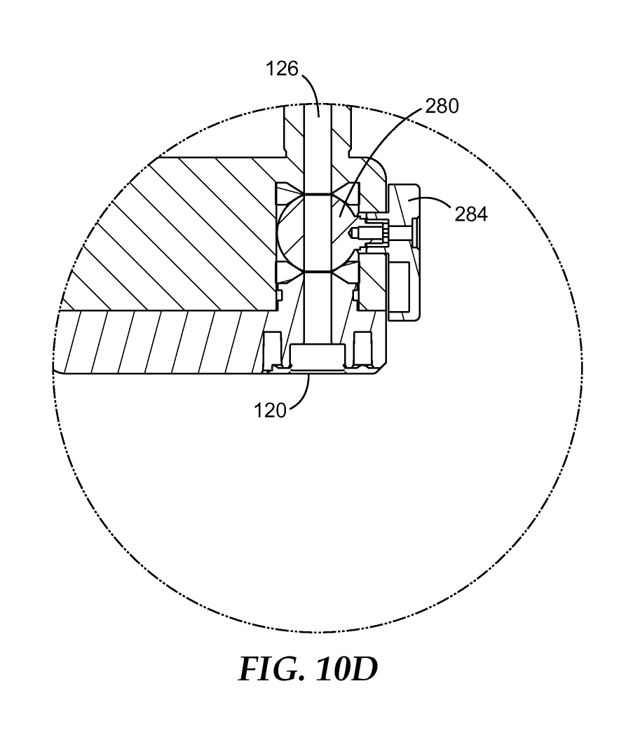

In some embodiments, the cartridge body 202 is generally cylindrical and the flow axis 201 is coaxial or at least parallel with the axis of the cylinder. Of course, other cartridge body 202 shapes are envisioned provided they are suitable for the operating conditions and any other design constraints of the particular application. Typically, the installation direction 203 is orthogonal to the flow axis 201, as shown in FIGS. 1, 2B-2C, 3, 4B-4C, 5, 6B, 9, and 10B-10C. It is envisioned that the installation direction 203 may slightly deviate from orthogonal to the flow axis 201 and still be considered orthogonal for purposes of the present disclosure. For example, the installation direction 203 may be within +/−5 degrees, preferably within +/−3 degrees, more preferably within +/−2 degrees, and even more preferably within +/−1 degree, of the true perpendicular direction from the flow axis 201 and still be considered orthogonal.

In one embodiment, the filter cartridge 200 comprises a first cartridge port 210 oriented parallel to the flow axis 201 at a first cartridge end 211. It is envisioned that the first cartridge port 210 may be coaxial with the flow axis 201, or may be offset from (but oriented parallel to) the flow axis 201. As shown throughout the appended Figures, the first cartridge port 210 comprises a first extending portion 230 moveable with respect to the cartridge body 202 along the flow axis 201 to a cartridge loading position 234 and a cartridge service position 236.

The filter cartridge 200 further comprises a second cartridge port 220 oriented parallel to the flow axis 201 at a second cartridge end 221. As with the first cartridge port 210, it is envisioned that the second cartridge port 220 may be coaxial with the flow axis 201, or may be offset from (but oriented parallel to) the flow axis 201.

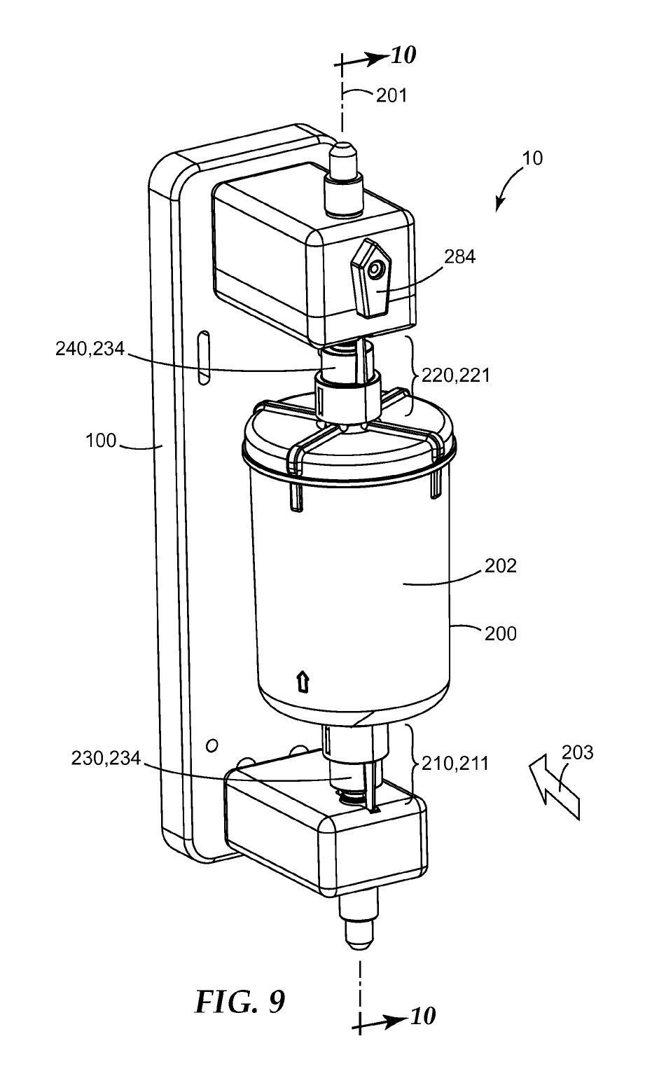

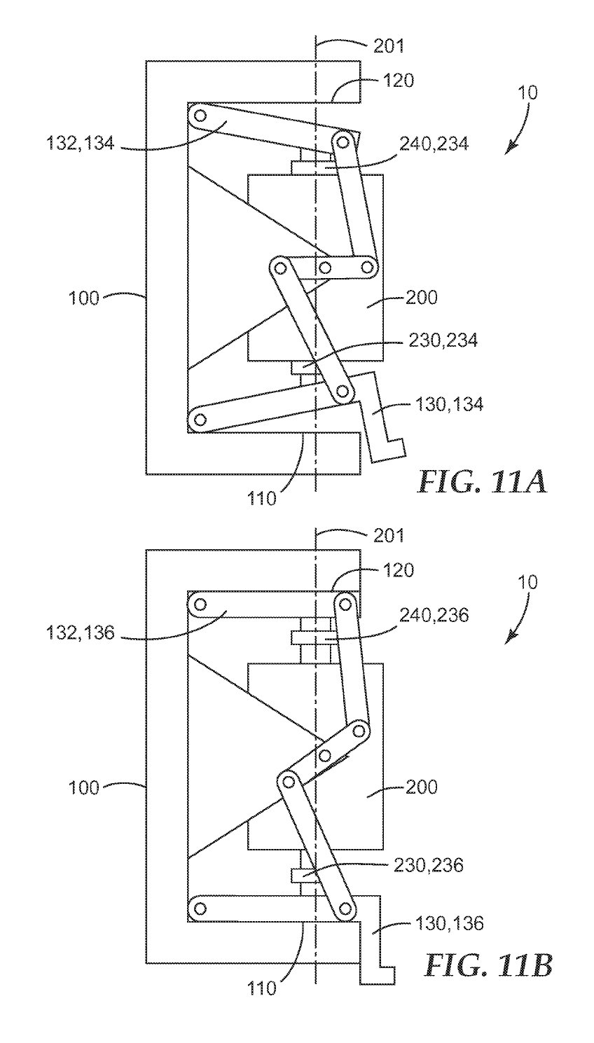

In some embodiments, such as those shown in FIGS. 1, 3, 5, 7, and associated detailed views, the second cartridge port 220 is static—i.e., the second cartridge port 220 is not moveable with respect to the cartridge body 202. In other embodiments, such as the ones shown in FIGS. 9 and 11A-11B, the second cartridge port 220 comprises a second extending portion 240 moveable to a cartridge loading position 234 and a cartridge service position 236.

It should be understood that, while several features and advantages are discussed below with respect to embodiments of the first extending portion 230, such features and advantages are equally applicable to embodiments of the second extending portion 240, in the event one is provided on the second manifold port 120. For purposes of simplifying the present disclosure, the term “extending portion 230, 240” is used herein to describe features of either or both of the first extending portion 230 and the second extending portion 240. Similarly, the term “cartridge port 210, 220” is used herein to describe features of either or both of the first cartridge port 110 and the second cartridge port 220. Also, the term “manifold port 110, 120” is used herein to describe features of either or both of the first manifold port 110 and the second manifold port 120.

In some embodiments, such as the ones shown in FIGS. 1, 5, 7, 11A-11B, and associated detailed views, the extending portion 230, 240 comprises a telescoping portion that telescopes toward and away from the cartridge body 202. In such embodiments, the telescoping portion typically comprises one or more internal seals 232, 242 to allow the telescoping portion to remain fluid tight against the filter cartridge 200 as it telescopes back and forth between the cartridge loading position 234 and the cartridge service position 236.

In one embodiment, not explicitly shown in the Figures, the extending portion 230, 240 comprises a rotating portion that rotates upon a thread or cam to slide toward and away from the cartridge body 202. In such embodiments, the rotating portion typically comprises one or more internal seals 232 to allow the rotating portion to remain fluid tight against the filter cartridge 200 as it rotates and slides to move back and forth between the cartridge loading position 234 and the cartridge service position 236.

In some embodiments, such as those shown in FIGS. 1, 3, 9, and associated detailed views, whether telescoping, rotating, or otherwise, the extending portion 230, 240 may comprise a piston seal 90 to seal the cartridge port 210, 220 in fluid connection with the manifold port 110, 120. It is envisioned that, where a piston seal 90 is provided, either or both of the cartridge port 210, 220 and the manifold port 110, 120 may comprise a piston sealing member 91, while the other comprises a piston sealing surface 92. In some circumstances, it may be advantageous to provide the piston sealing member 91 on the cartridge port 210, 220. For example, it may be desirable to ensure that the piston sealing member 91 is replaced each time the filter cartridge 200 is replaced. In other circumstances, it may be advantageous to provide the piston sealing member 91 on the manifold port 110, 120. For example, it may be desirable avoid the cost of providing one or more new piston sealing members 91 on every replacement filter cartridge 200. It is also envisioned that, where a piston seal 90 is employed, either the cartridge port 210, 220 or manifold port 110, 120 may comprise a male portion, while the other comprises a female portion to receive the male portion. In the embodiments shown in the Figures, the cartridge port 210, 220 comprises a male portion and the manifold port 110, 120 comprises a female portion. In any event, a piston sealing member 91 may comprise, for example, an o-ring, a gasket, an overmolded seal, a wiper, or any other member or members designed to provide a fluid seal between parts that are movable in relation to one another.

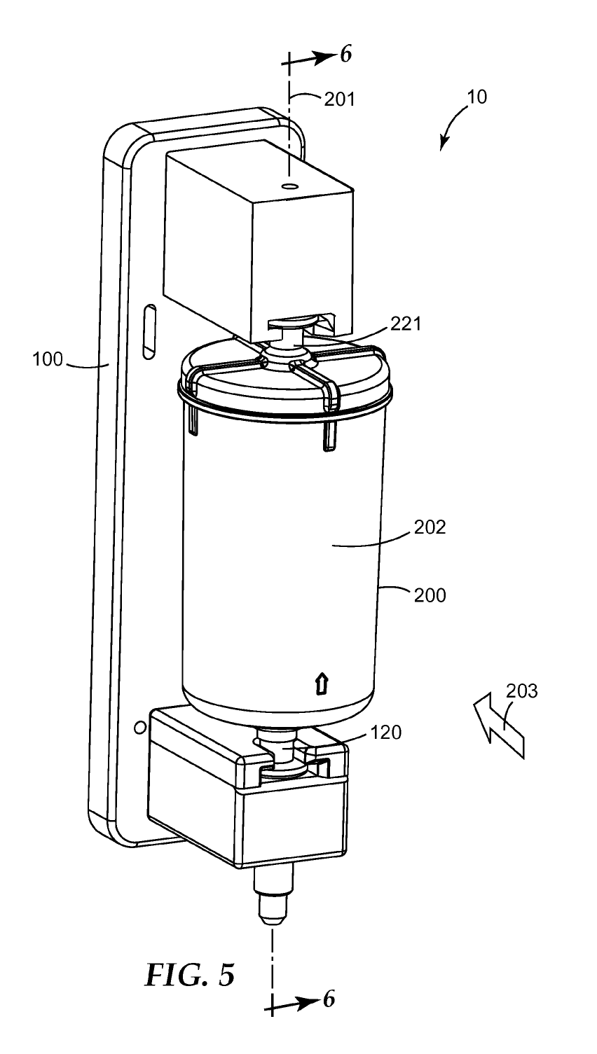

In some embodiments, such as those shown in FIGS. 5, 7-8, and associated detailed views, whether telescoping, rotating, or otherwise, the cartridge port 210, 220 comprises a face seal 93 to seal the cartridge port 210, 220 in fluid connection with the manifold port 110, 120. It is envisioned that either or both of the cartridge port 210, 220 and the manifold port 110, 120 may comprise a face sealing member 94, while the other comprises a face sealing surface 95. In some circumstances, it may be advantageous to provide the face sealing member 94 on the cartridge port 210, 220. For example, it may be desirable to ensure that the face sealing member 94 is replaced each time the filter cartridge 200 is replaced. In other circumstances, it may be advantageous to provide the face sealing member 94 on the manifold port 110, 120. For example, it may be desirable avoid the cost of providing one or more new face sealing members 94 on every replacement filter cartridge 200. In any event, a face sealing member 94 may comprise, for example, an o-ring, a gasket, an overmolded seal, or any other member or members designed to provide a fluid seal between parts that are compressed or held in static relation to one another.

While the possibility of using either a face seal 93 or a piston seal 90 is envisioned for both the first cartridge port 210 and the second cartridge port 220, it should be understood that piston seals may have certain advantages over face seals, depending on the desired application.

For example, a piston sealing member 91 seals by sliding along a piston sealing surface 92 in a direction parallel to the flow axis 201. Consequentially, any slight axial movement or variation in location of the piston sealing member 91 with respect to the piston sealing surface 92 during operation of the filtration system 10 does not result in disruption of the piston seal 90. Therefore, relative axial movement is tolerated and forceful axial compression of the piston seal 90 is therefore not necessary.

In contrast, when a face seal 93 configuration is employed—i.e., wherein a seal is created by axial force on a face sealing member 94 against a face sealing surface 95 oriented perpendicular to the flow axis 201—care must be taken to avoid any relative separating axial movement. In such a face seal 93 configuration, any such movement would tend to disrupt or break the seal, allowing fluid bypass. In such face seal 93 configurations, especially where elevated fluid pressure may be encountered, forceful axial compression of the face seal 93 may be required.

Thus, while it is envisioned that a face seal 93 may be employed within the scope of the present disclosure, piston seals may be preferred in some embodiments because they can result in a more forgiving connection.

In the CMP slurry filtration application described above, for example, the upstream side of the filter cartridge 200 (i.e., at the first cartridge port 210) typically operates at an elevated pressure, while the downstream side (i.e., at the second cartridge port 220) operates at near atmospheric pressure. By “elevated pressure,” we mean greater than or equal to about 10 psi (about 6.895e+004 newtons/square meter), typically in a range from about 10 psi (about 6.895e+004 newtons/square meter) to about 50 psi (about 3.447e+005 newtons/square meter), and even more typically in a range from about 15 psi (about 1.034e+005 newtons/square meter) to about 25 psi (about 1.724e+005 newtons/square meter), including any range or combination of ranges therein. By “near atmospheric pressure,” we mean in a range from about 0 psi (about 0 newton/square meter) to about 5 psi (about 3.447e+004 newtons/square meter), typically in a range from about 0 psi (about 0 newton/square meter) to about 2 psi (about 1.379e+004 newtons/square meter), and even more typically in a range from about 0 psi (about 0 newton/square meter) to about 1 psi (about 6895 newtons/square meter), including any range or combination of ranges therein. Because of this pressure gradient across the filter cartridge 200, it may be advantageous to provide at least the first cartridge port 210 with a piston seal 90, while a face seal 93 may suffice for the second cartridge port 220.

However, it is envisioned that a face seal 93 may be employed even on the first cartridge port 210 at elevated pressure, as in the embodiments shown in FIGS. 5, 7-8, and associated detailed views. For example, some of the reduced dimensional flexibility typically encountered when using face seals may be mitigated or made irrelevant by inclusion of a first extending portion 230 on the first cartridge port 210. Because the first extending portion 230 is moveable with respect to the cartridge body 202, the cartridge body 202 may move without breaking or disrupting the face seal 93 between the first extending portion 230 and the first manifold port 110. Moreover, any dimensional variation in either the filter manifold 100 or the filter cartridge 200 along the flow axis 201 can be canceled out by movement of the first extending portion 230 with respect to the cartridge body 202 to meet the given geometry of the first manifold port 110. In this way, longer and shorter filter cartridges may be made to successfully and reliably seal into filter manifolds having longer or shorter reception areas.

In some embodiments, such as those shown in FIGS. 1, 11A-11B, and associated detailed views, the filter manifold 100 may comprise a first carriage 130 moveable to a manifold loading position 134 and a manifold service position 136. The first carriage 130 operates to receive and carry the first extending portion 230 back and forth between the cartridge loading position 234 and the cartridge service position 236. Although the first carriage 130 may or may not move along the flow axis 201, it can carry the first extending portion 230 along the flow axis 201 to properly fluidly connect with the first manifold port 110. For example, in embodiments where there is a piston seal 90 between the first cartridge port 110 and the first manifold port 110, the first cartridge port 110 typically must move in along the flow axis 201 in order to properly fluidly connect.

In embodiments where the second cartridge port 220 comprises a second extending portion 240 moveable to a cartridge loading position 234 and a cartridge service position 236, the filter manifold 100 may further comprise a second carriage 132 moveable to a manifold loading position 134 and a manifold service position 136, as shown in FIGS. 11A-11B. As with the first carriage 130, the second carriage 132 operates to receive and carry the second extending portion 240 back and forth between the cartridge loading position 234 and the cartridge service position 236.

Similarly, although the second carriage 132 may or may not move along the flow axis 201, it can carry the second extending portion 240 along the flow axis 201 to properly fluidly connect with the second manifold port 120. For example, in embodiments where there is a piston seal 90 between the second cartridge port 220 and the second manifold port 120, the second cartridge port 220 typically must move in along the flow axis 201 in order to properly fluidly connect.

It should be understood that, while several features and advantages are discussed below with respect to embodiments of the first carriage 130, such features and advantages are equally applicable to embodiments of the second carriage 132, in the event one is provided. For purposes of simplifying the present disclosure, the term “carriage 130,132” is used herein to describe features of either or both of the first carriage 130 and second carriage 132.

In one embodiment, as shown in FIGS. 1, 11A-11B, and associated detailed views, the carriage 130, 132 is hingedly coupled to the filter manifold 100 and comprises a receiving portion 131 to receive an engaging portion 231 on the first extending portion 230. When the carriage 130, 132 is in the manifold loading position 234 and the extending portion 230, 240 is in the cartridge loading position 234, the receiving portion 131 is made available to the engaging portion 231 while a filter cartridge 200 is being loaded into the filter manifold 100 in the installation direction 203. When the filter cartridge 200 is loaded in the installation direction 203, the extending portion 230, 240 is fully engaged in the receiving portion 131. Then, the carriage 130, 132 can hingedly move to the manifold service position 136, carrying the extending portion 230, 240 into the cartridge service position 236 to fluidly connect the cartridge port 210, 220 to the manifold port 110, 120.

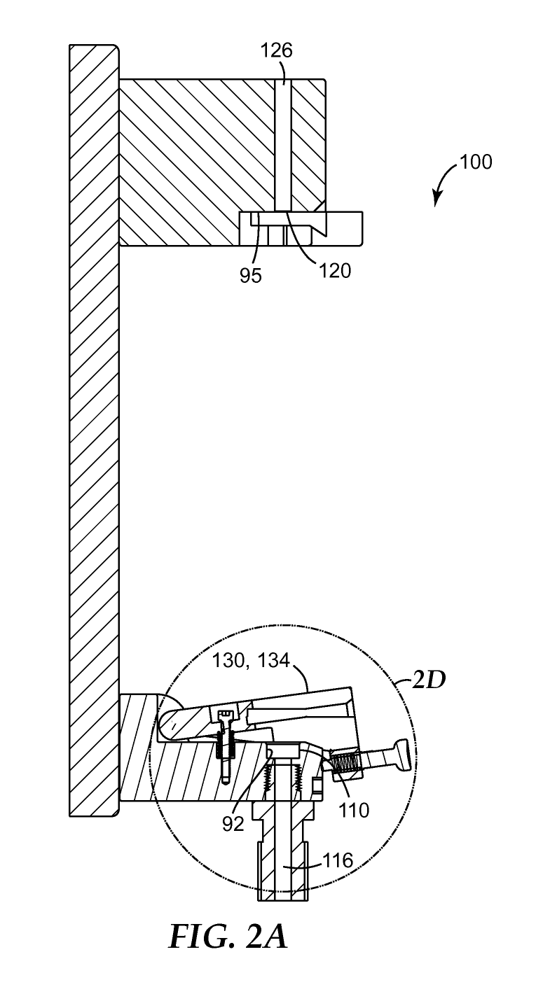

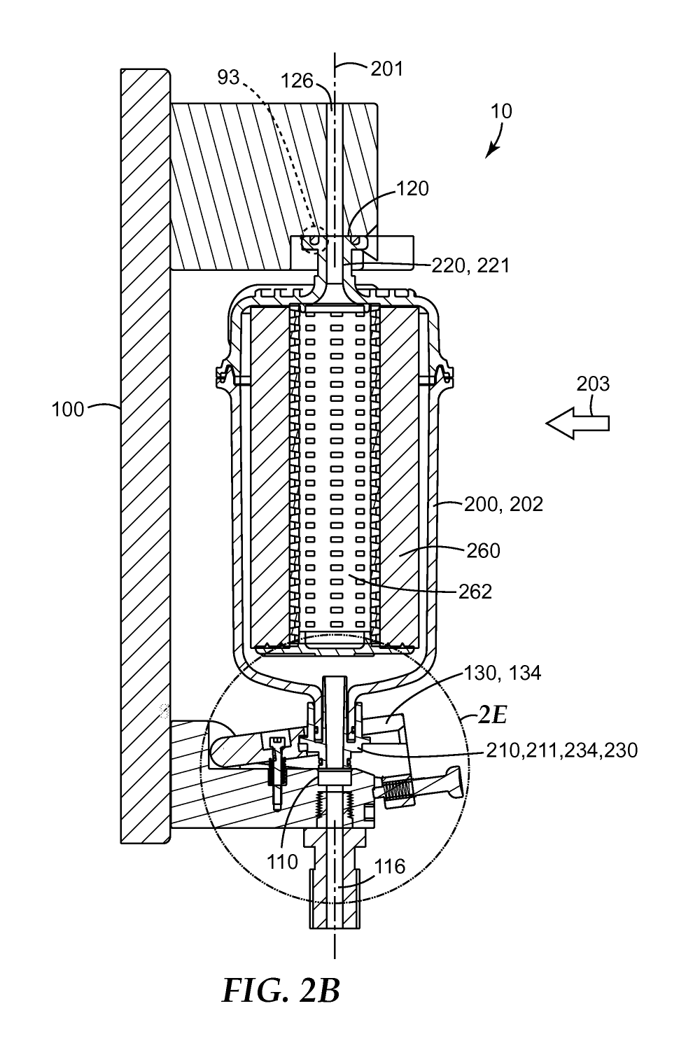

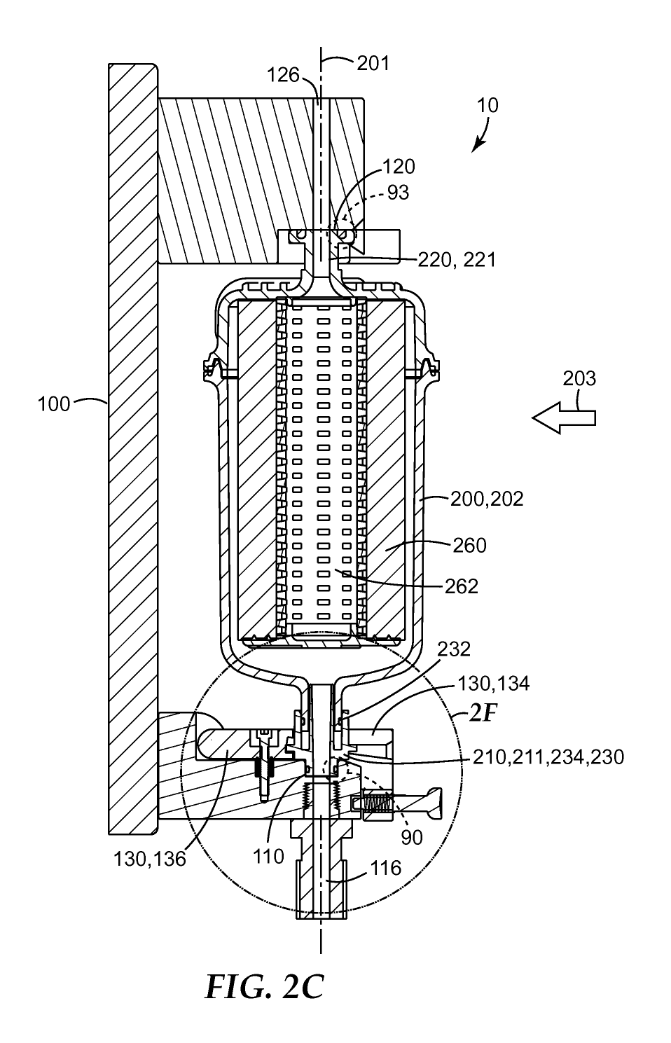

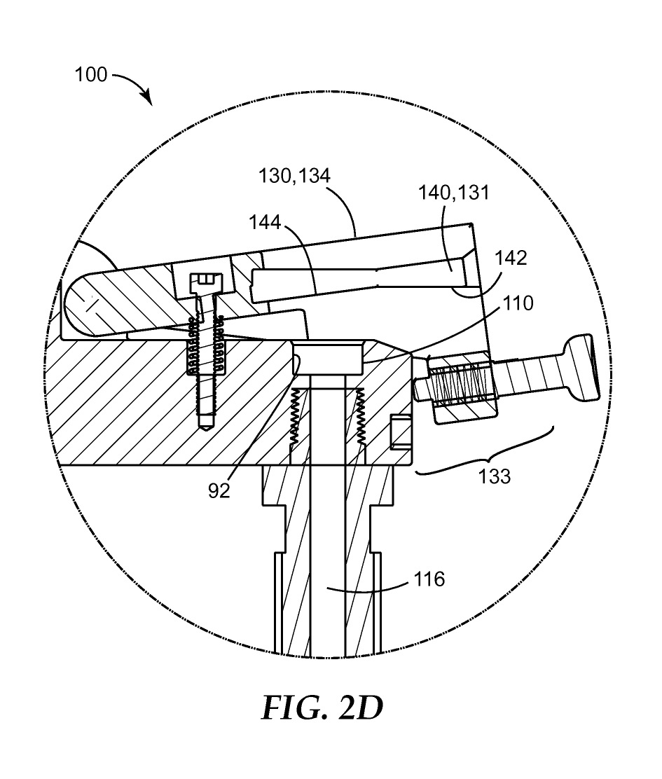

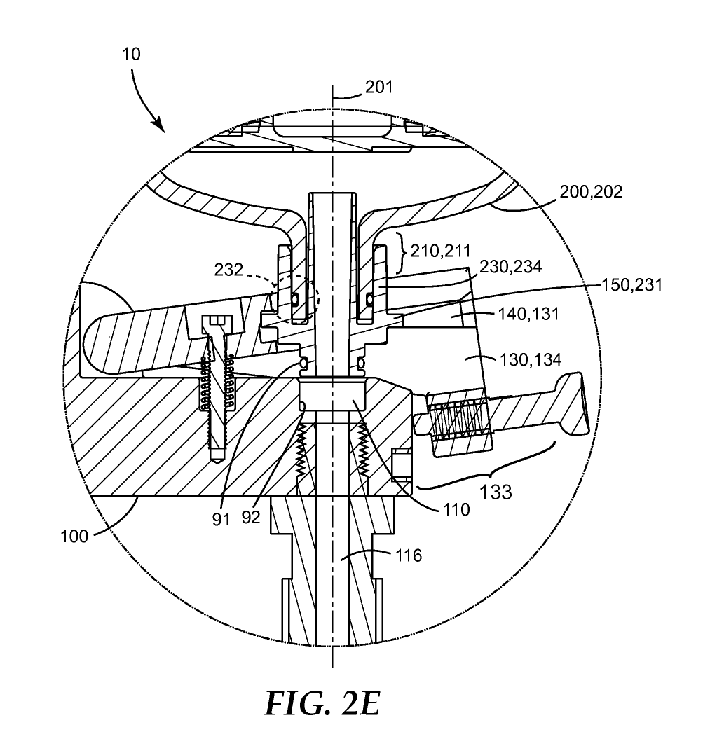

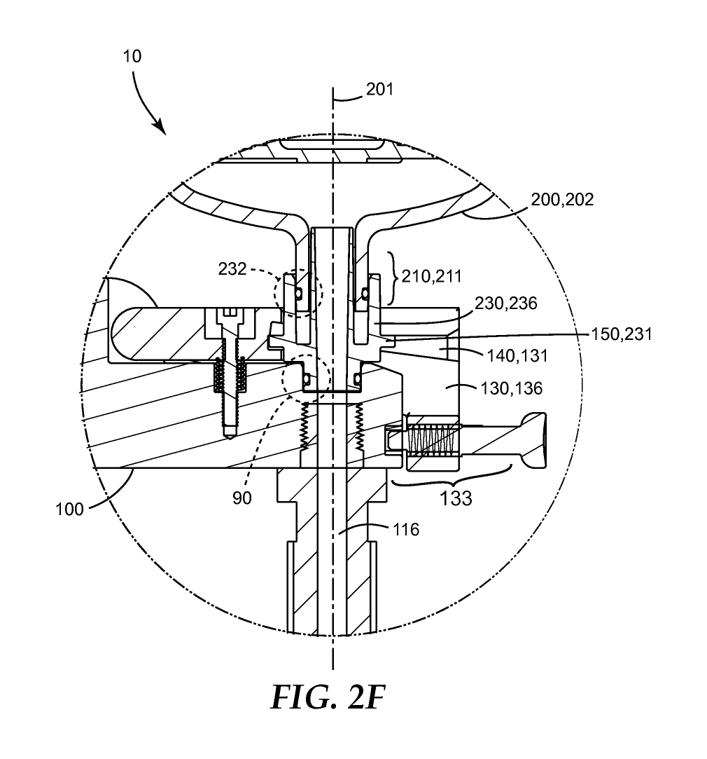

As shown in FIGS. 2A-2F, the receiving member 131 may comprise one or more slots 140 while the engaging member 231 comprises one or more flanges 150 to be received by the one or more slots 140. However, it is also envisioned that the engaging member 231 may comprise one or more slots 140 while the receiving member 131 comprises one or more flanges 150 to be engaged by the one or more slots 140. In one embodiment, the flange 150 is a simple disc-shaped flange 150 as shown in FIGS. 2E-2F, while the slot 140 comprises a compound profile that is design to both (i) guide the flange 150 in the installation direction 203 into the carriage 130, 132 while the carriage 130, 132 is in the manifold loading position 134; and (ii) guide the flange 150 along the flow axis 201 so that the carriage 130, 132 can carry the extending portion 230, 240 into fluid connection with the manifold port 110, 120.

In one embodiment, as best shown in FIG. 2D, a slot 140 comprising a compound profile comprises a first slot portion 142 adjoining a second slot portion 144, wherein the first slot portion 142 is disposed along the installation direction 203 when the first carriage 130 is in the manifold loading position 134, and the second slot portion 144 is disposed along the installation direction 203 when the when the first carriage 130 is in the manifold service position 136. Such a compound profile can allow the slot 140 to “rotate” about the flange 150 as the first carriage 130 is hingedly moved from the manifold loading position 134 to the manifold service position 136, while successfully pushing the flange 150 along the direction of the flow axis 201, as shown in FIGS. 2E and 2F, respectively.

In some such embodiments, the carriage 130, 132 or the filter manifold 100 may comprise a locking member 133 to lock the carriage 130, 132 into the manifold service position 136. Provision of such a locking member 133 may be desirable in certain circumstances, for example, where fluid pressure at the fluid source 116 could otherwise act upon the first cartridge port 110 to separate the first cartridge port 110 from the first manifold port 110. In one embodiment, the locking member 133 comprises a pin and a detent into which the pin can lock. For example, as shown in FIGS. 2D-2F, the locking member 133 comprises a spring-loaded pin disposed on the first carriage 130, along with a detent disposed on the filter manifold 100. In that embodiment, the spring loaded pin can snap into the detent when the first carriage 130 is lowered into the manifold service position 136. Depending on the embodiment, a similar assembly could be provided at the second carriage 132 in addition to, or instead of, at the first carriage 130.

In one embodiment, not explicitly shown in the appended Figures, the carriage 130, 132 rotates to move to the manifold loading position 134 and the manifold service position 136. In doing so, the rotating cartridge 130, 132 can move the extending portion 230, 240 to the cartridge loading position 234 and the cartridge service position 236, respectively. In one embodiment, the carriage 130, 132 rotates about the flow axis 201. Rotational engagement between the carriage 130, 132 and the extending portion 230, 240 may comprise, for example, threads, cams, or other cooperating geometry that allows rotation of one part to cause translation of the cooperating part. In one embodiment, the carriage 130, 132 and the extending portion 230, 240 are coaxial such that rotation of the carriage 130, 132 about, or parallel to, the flow axis 201 causes translation of the extending portion 230, 240 along, or parallel to, the flow axis 201. In another embodiment, the carriage 130, 132 and the extending portion 230, 240 are not coaxial such that rotation of the carriage 130, 132 about an axis spaced from the flow axis 201 causes translation of the extending portion 230, 240 along the flow axis 201.

Although not shown in the Figures, it is envisioned that a locking member 133 as described above may be employed when using a rotating carriage 130, 132 in order to secure the extending portion 230, 240 into the cartridge service position 236. For example, a spring-loaded pin may be configured to lock into a detent when the carriage 130, 132 is rotated into the manifold service position 136, the pin being releasable from the detent to allow rotation of the carriage 130, 132 back into the manifold loading position 134.

Turning now to FIGS. 11A-11B, in some embodiments, the filter manifold 100 comprises a first carriage 130 and a second carriage 132 that can move in unison to the manifold loading position 134 and the manifold service position 136. As shown, a linkage connects the first carriage 130 to the second carriage 132 such that movement of the first carriage 130 in one direction is effective to move the second carriage 132 in an opposing direction. Other mechanisms could be employed to cause simultaneous motion. For example, a gear train (or a combination of a gear train with a linkage) could be employed to accomplish the required opposing motion. In some such embodiments, the filter manifold 100 may hold the cartridge body 202 to prevent the cartridge body 202 from moving along the flow axis 201. For example, an arm or cradle may project from the filter manifold 100 to engage the cartridge body 202 to fix movement along the flow axis 201 while allowing free movement of the extending portions 230, 240. Such a mechanism can hold the extending portion 230, 240 the correct distance from the manifold port 110, 120 during loading of the filter cartridge 200 while then allowing the extending portion 230, 240 to move along the flow axis 201 to accurately fluidly connect to the manifold port 110, 120. It is envisioned that all features and advantages described elsewhere in the present disclosure relating to a first or second carriage 132 may be applicable to embodiments as shown in FIGS. 11A-11B.

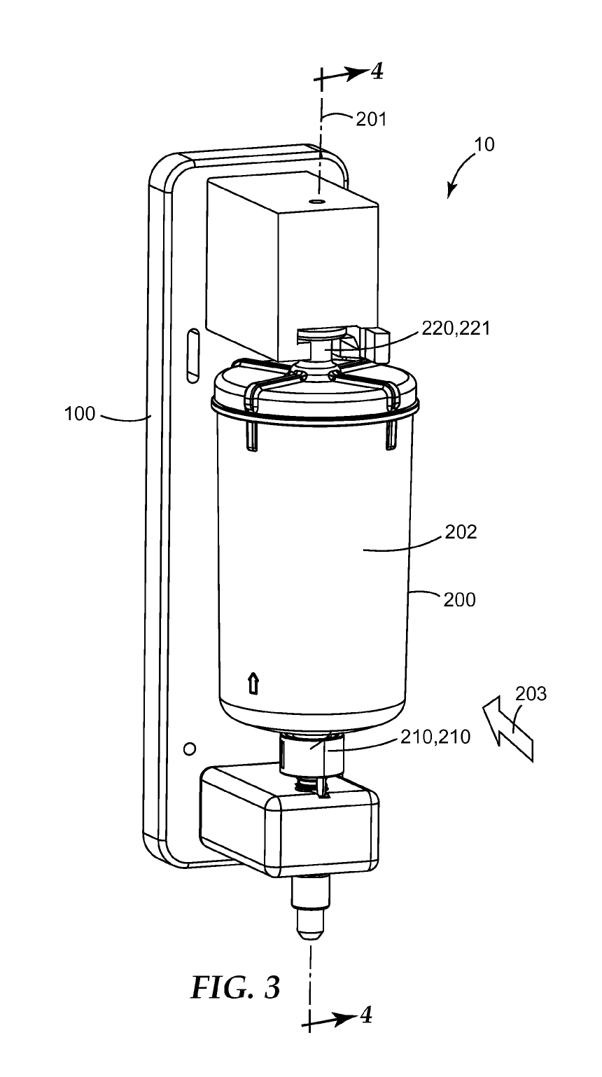

In some embodiments, as shown in FIGS. 3, 9, and associated detailed views, the cartridge body 202 is rotatable with respect to the extending portion 230, 240 to cause the extending portion 230, 240 to be urged from the cartridge loading position 234 to the cartridge service position 236. In one embodiment, as the cartridge body 202 rotates, the extending portion 230, 240 translates. This translation can enable the cartridge port 210, 220 to fluidly connect to the manifold port 110, 120. For example, translation of the extending portion 230, 240 can facilitate a piston seal 90 against the manifold port 110, 120.

Rotational engagement between the cartridge body 202 and the extending portion 230, 240 may comprise, for example, threads, cams, or other cooperating geometry that allows rotation of the cartridge body 202 to cause translation of the extending portion 230, 240. In such embodiments, one or both of the cartridge body 202 or the extending portion 230, 240 typically comprises one or more internal seals 232, 242 to allow the extending portion 230, 240 to remain fluid tight against the filter cartridge 200 as it rotates and slides to move back and forth between the cartridge loading position 234 and the cartridge service position 236.

In such embodiments, such as those shown in FIGS. 3, 9 and associated detailed views, the extending portion 230, 240 and the filter manifold 100 may each comprise one or more a retention members 98 that cooperate to prevent rotation of the extending portion 230, 240 with respect to the filter manifold 100 when the cartridge body 202 is rotated with respect to the extending portion 230, 240. The retention members 98 may comprise, for example, cooperating male and female parts such as cooperating pins and holes, or cooperating protrusions and channels.

In the embodiments shown, the extending portion 230, 240 comprises male retention members 98, while the manifold port 110, 120 comprises female retention members 98. In that embodiment, the retention members 98 can serve dual roles. First, they can properly align the filter cartridge 200 with the filter manifold 100 as it is loaded in the installation direction 203. This is accomplished by the tips of the male retention members 98 on the extending portion 230, 240 translating in the installation direction 203 through the channels formed by the female retention members 98 on the manifold port 110, 120. Second, once the filter cartridge 200 is loaded and the cartridge body 202 begins to rotate about the flow axis 201, the retention member 98 can cooperate to prevent rotation of the extending portion 230, 240, while guiding the extending portion 230, 240 along the flow axis 201 to fluidly connect with the manifold port 110, 120.

In the above embodiments, the filter manifold 100 may hold the cartridge body 202 to allow the cartridge body 202 to rotate about the flow axis 201 but not allow the cartridge body 202 to move along the flow axis 201. For example, an arm or cradle (not shown) may project from the filter manifold 100 to engage the cartridge body 202 to fix movement along the flow axis 201 while allowing free rotation. Such a mechanism can hold the extending portion 230, 240 the correct distance from the manifold port 110, 120 during loading of the filter cartridge 200 while then allowing the extending portion 230, 240 to move along the flow axis 201 to accurately fluidly connect to the manifold port 110, 120.

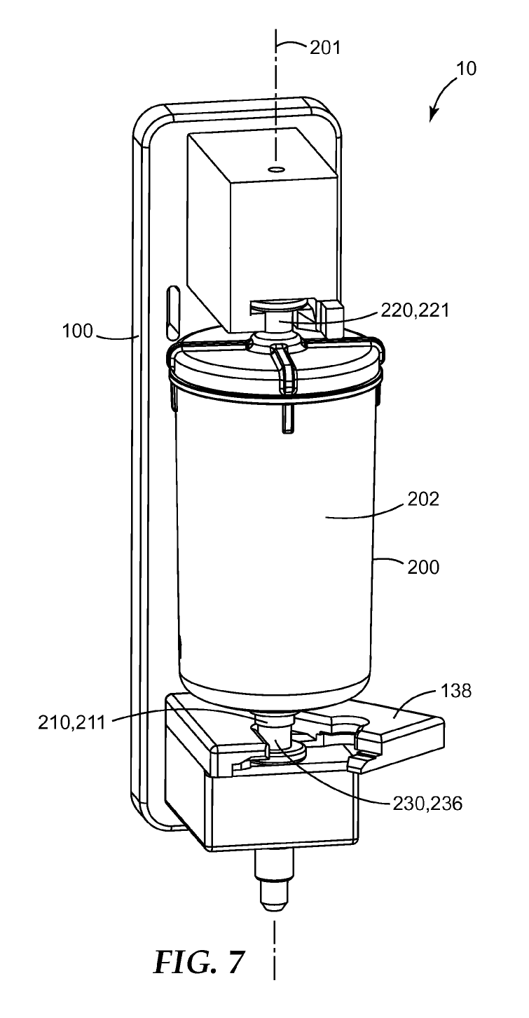

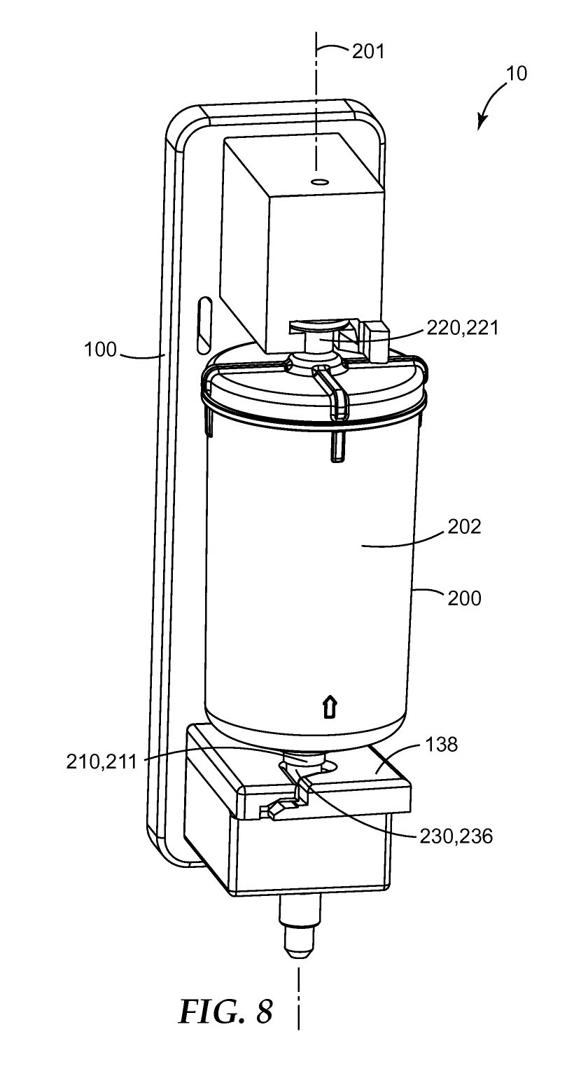

As shown in FIGS. 7 and 8, the filter manifold 100 may comprise a one or more clamps 138 to fix and retain a cartridge port 210, 220 in fluid connection with a corresponding manifold port 110, 120. Such a clamp 138 may be hingedly fixed to the filter manifold 100 to allow it to swing away into an open position (i.e., a manifold loading position 134), as shown in FIG. 7, to accommodate a cartridge port 210, 220. Then, after the cartridge port 210, 220 is loaded in place, the clamp 138 can swing back (i.e., into a manifold service position 136) to securely retain the cartridge port 210, 220 during operation, as shown in FIG. 8. While the clamp 138 shown comprises two clamp portions (one fixed and one moveable), it is also envisioned, for example, that the clamp 138 could be entirely moveable to accomplish the same function.

In some embodiments, such as the one shown in FIG. 9 and associated detailed views, the filter manifold 100 comprises a valve 280 to selectively regulate fluid flow through either or both of the fluid source 116 or the fluid exit 126. Typically, such a valve 280 may be disposed only in the fluid exit 126. In some embodiments, the valve 280 is actuable by a valve handle 284. While not required, the valve 280 typically comprises a sanitary ball valve 280 that can assist in the prevention of fluid stagnation by minimizing dead volume and turbulence in the fluid line while on, off, and during actuation. While a valve 280 is only shown in certain of the appended Figures, it may be provided in any disclosed embodiment.

It should be noted that the embodiments shown in the appended Figures are not exhaustive of the embodiments described under the present disclosure. As earlier described, different combinations of the disclosed cartridge ports 210, 220, extending portions 230, 240, manifold ports 110, 120, and carriages 130, 132 are envisioned within the scope of the present disclosure. For example, the first cartridge end 211 and first manifold port 110 may comprise any disclosed configuration, while the second cartridge end 221 and second manifold port 120 may comprise the same or different configuration, so long as they are compatible and useful for a given application.

Various modifications and alterations of the invention will be apparent to those skilled in the art without departing from the spirit and scope of the invention. It should be understood that the invention is not limited to illustrative embodiments set forth herein.

1. A filtration system comprising:
a filter manifold and a filter cartridge;
the filter cartridge comprising:
a cartridge body comprising a flow axis and an installation direction orthogonal to the flow axis;
a first cartridge port oriented parallel to the flow axis at a first cartridge end, the first cartridge port comprising a first extending portion moveable with respect to the cartridge body along the flow axis to a cartridge loading position and a cartridge service position; and
a second cartridge port oriented parallel to the flow axis at a second cartridge end;
the filter manifold comprising:
a first manifold port to fluidly connect to the first cartridge port along the flow axis when the first extending portion is in the cartridge service position; and
a second manifold port to fluidly connect to the second cartridge port.

2. The filtration system of claim 1 wherein the fluid connection between the first manifold port and the first cartridge port comprises a piston seal.

3. The filtration system of claim 1 wherein the first manifold port operates at an elevated pressure and the second manifold port operates near atmospheric pressure.

4. The filtration system of claim 1 wherein the filter manifold comprises a first carriage moveable to a manifold loading position and a manifold service position, the first carriage to receive and carry the first extending portion in the installation direction when in the first carriage is in the manifold loading position and the first extending portion is in the cartridge loading position;
wherein the first manifold port fluidly connects to the first cartridge port along the flow axis when the first carriage moves to the manifold service position to carry the first extending portion into the cartridge service position.

5. The filtration system of claim 4 wherein the first carriage rotates to move to the manifold loading position and the manifold service position.

6. The filtration system of claim 1 wherein the second manifold port fluidly connects to the second cartridge port in the installation direction.

7. The filtration system of claim 1 wherein the second cartridge port comprises a second extending portion moveable with respect to the cartridge body along the flow axis to a cartridge loading position and a cartridge service position;
wherein the second manifold port fluidly connects to the second cartridge port along the flow axis when the second extending portion is in the cartridge service position.

8. The filtration system of claim 7 wherein the fluid connection between the second manifold port and the second cartridge port comprises a piston seal.

9. The filtration system of claim 7 wherein the filter manifold comprises a second carriage moveable to a manifold loading position and a manifold service position, the second carriage to receive and carry the second extending portion in the installation direction when in the second carriage is in the manifold loading position and the second extending portion is in the cartridge loading position;
wherein the second manifold port fluidly connects to the second cartridge port along the flow axis when the second carriage moves to the manifold service position to carry the second extending portion into the cartridge service position.

10. The filtration system of claim 9 wherein the second carriage rotates to move to the manifold loading position and the manifold service position.

11. The filtration system of claim 9 wherein the first carriage and the second carriage are movable in unison to the manifold loading position and the manifold service position.

12. The filtration system of claim 9 wherein the cartridge body is rotatable with respect to the first extending portion, wherein rotation of the cartridge body with respect to the first extending portion about the flow axis urges the first extending portion into the cartridge service position.

13. The filtration system of claim 12 wherein the first extending portion and the filter manifold each comprise a retention member, the retention members cooperating to prevent rotation of the first extending portion with respect to the filter manifold when the cartridge body is rotated about the flow axis.

14. The filtration system of claim 7 wherein the cartridge body is rotatable with respect to the second extending portion, wherein rotation of the cartridge body with respect to the second extending portion about the flow axis urges the second extending portion into the cartridge service position.

15. The filtration system of claim 14 wherein the second extending portion and the filter manifold each comprise a retention member, the retention members cooperating to prevent rotation of the second extending portion with respect to the filter manifold when the cartridge body is rotated about the flow axis.

16. The filtration system of claim 12 wherein the filter manifold holds the cartridge body to allow the cartridge body to rotate about the flow axis but not allow the cartridge body to move along the flow axis.

17. A filter cartridge comprising:
a cartridge body comprising a flow axis and an installation direction orthogonal to the flow axis;
a first cartridge port oriented parallel to the flow axis at a first cartridge end, the first cartridge port comprising a first extending portion moveable with respect to the cartridge body along the flow axis to a cartridge loading position and a cartridge service position; and
a second cartridge port oriented parallel to the flow axis at a second cartridge end.

18. The filter cartridge of claim 17 wherein the first cartridge port comprises one of a piston sealing member or a piston sealing surface.

19. The filter cartridge of claim 17 wherein the second cartridge port comprises a second extending portion moveable with respect to the cartridge body along the flow axis to a cartridge loading position and a cartridge service position.

20. The filter cartridge of claim 19 wherein the second cartridge port comprises one of a piston sealing member or a piston sealing surface.

21. The filter cartridge of claim 17 wherein the cartridge body is rotatable with respect to the first extending portion, wherein rotation of the cartridge body with respect to the first extending portion about the flow axis urges the first extending portion into the cartridge service position.

22. The filter cartridge of claim 21 wherein the first extending portion comprises a retention member, the retention member cooperating with a retention member on a compatible filter manifold to prevent rotation of the first extending portion with respect to the filter manifold when the cartridge body is rotated about the flow axis.

23. The filter cartridge of claim 17 wherein the cartridge body is rotatable with respect to the second extending portion, wherein rotation of the cartridge body with respect to the second extending portion about the flow axis urges the second extending portion into the cartridge service position.

24. The filter cartridge of claim 23 wherein the second extending portion comprises a retention member, the retention member cooperating with a retention member on a compatible filter manifold to prevent rotation of the second extending portion with respect to the filter manifold when the cartridge body is rotated about the flow axis.

25. The filter cartridge of claim 21 wherein the filter manifold holds the cartridge body to allow the cartridge body to rotate about the flow axis but not allow the cartridge body to move along the flow axis.

26. A method of assembling a filtration system comprising:
a filter manifold and a filter cartridge;
the filter cartridge comprising:
a cartridge body comprising a flow axis and an installation direction orthogonal to the flow axis;
a first cartridge port oriented parallel to the flow axis at a first cartridge end, the first cartridge port comprising a first extending portion moveable with respect to the cartridge body along the flow axis to a cartridge loading position and a cartridge service position; and
a second cartridge port oriented parallel to the flow axis at a second cartridge end;
the filter manifold comprising:
a first manifold port to fluidly connect to the first cartridge port along the flow axis when the first extending portion is in the cartridge service position; and
a second manifold port to fluidly connect to the second cartridge port;
the method comprising:
loading the filter cartridge into the filter manifold in the installation direction while the first extending portion is in the cartridge loading position; and
moving the first extending portion into the cartridge service position to fluidly connect the first cartridge port to the first manifold port.

27. The method of claim 26 wherein fluidly connecting the first cartridge port to the first manifold comprises engaging a piston seal.

28. The method of claim 26 further comprising operating the operating the first manifold port at an elevated pressure and the second manifold port at near atmospheric pressure.

29. The filtration system of claim 26 wherein the filter manifold comprises a first carriage moveable to a manifold loading position and a manifold service position, the first carriage to receive and carry the first extending portion in the installation direction when in the first carriage is in the manifold loading position and the first extending portion is in the cartridge loading position;
the method comprising:
moving the first carriage from the manifold loading position to the manifold service position to carry the first extending portion into the cartridge service position.

30. The method of claim 29 wherein moving the first carriage from the manifold loading position to the manifold service position comprises rotating the first carriage.

31. The method of claim 26 comprising fluidly connecting the second manifold port to the second cartridge port in the installation direction.

32. The filtration system of claim 26 wherein the second cartridge port comprises a second extending portion moveable with respect to the cartridge body along the flow axis to a cartridge loading position and a cartridge service position;
the method comprising:
moving the second extending portion into the cartridge service position to fluidly connect the second cartridge port to the second manifold port.

33. The method of claim 32 wherein fluidly connecting the second cartridge port to the second manifold comprises engaging a piston seal.

34. The method of claim 32 wherein the manifold comprises a second carriage moveable to a manifold loading position and a manifold service position, the second carriage to receive and carry the second extending portion in the installation direction when in the second carriage is in the manifold loading position and the second extending portion is in the cartridge loading position;
the method comprising:
moving the second carriage from the manifold loading position to the manifold service position to carry the second extending portion into the cartridge service position.

35. The method of claim 34 wherein moving the second carriage from the manifold loading position to the manifold service position comprises rotating the second carriage.

36. The method of claim 34 comprising moving the first carriage and the second carriage in unison to the manifold loading position and the manifold service position.

37. The method of claim 26 wherein the cartridge body is rotatable with respect to the first extending portion;
the method comprising:
rotating the cartridge body with respect to the first extending portion about the flow axis to urge the first extending portion into the cartridge service position.

38. The method of claim 37 wherein the first extending portion and the filter manifold each comprise a retention member;
the method comprising:
the retention members on the first extending portion and the filter manifold cooperating to prevent rotation of the first extending portion with respect to the filter manifold when the cartridge body is rotated about the flow axis.

39. The method of claim 32 wherein the cartridge body is rotatable with respect to the second extending portion,
the method comprising:
rotating the cartridge body with respect to the second extending portion about the flow axis to urge the second extending portion into the cartridge service position.

40. The method of claim 39 wherein the second extending portion and the filter manifold each comprise a retention member;
the method comprising:
the retention members on the second extending portion and the filter manifold cooperating to prevent rotation of the second extending portion with respect to the filter manifold when the cartridge body is rotated about the flow axis.

41. The method of claim 37 comprising the filter manifold holding the cartridge body to allow the cartridge body to rotate about the flow axis but not allow the cartridge body to move along the flow axis.
